(19) United States
(12) Patent Application Publication
(10) Pub. No.: US 2005/0235049 A1
(43) Pub. Date: Oct. 20, 2005

(54) System and method for monitoring startup processes of remote computers by a local server

(75) Inventor: Yu-Tsung Liu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/078,167

(22) Filed: Mar. 11, 2005

(30) Foreign Application Priority Data
Mar. 30, 2004 (TW) 93108611

(51) Int. Cl. G06F 15/16

(52) U.S. Cl. 709/219

(57) ABSTRACT

A system for monitoring startup processes of remote computers by a local server includes: a local server (3) for executing a monitoring program (31) to send requests for acquiring startup images, and to receive and display the startup images; remote computers (1); and a network (2) connecting the local server with the remote computers. Each remote computer outputs startup images during the startup process, receives a request for acquiring the startup images from the local server, and transmits the startup images to the local server. The remote computer includes a PCI (Peripheral Component Interconnect) monitoring & managing card (10) for detecting a VGA (Video Graphics Array) mode, capturing the corresponding VGA data in accordance with the detected VGA mode and translating the captured VGA data into the startup images. A related method is also disclosed.

### BACKGROUND OF THE INVENTION

1. Field of the Invention

The present invention relates to systems and methods for monitoring startup processes of computers, and more particularly to a system and method for monitoring startup processes of remote computers by a local server.

2. Prior Art

In a typical computer system (such as a personal computer under the IBM architecture), a BIOS (Basic Input/Output System) performs the whole initialization and test of the system when the system boots (also called startup). When the computer starts up, the BIOS tests the components of the computer, including the CPU (Central Processing Unit), main memory, ROM (Read Only Memory), motherboard, CMOS (Complementary Metal-Oxide Semiconductor) memory, serial interface, parallel interface, floppy disk, hard disk, keyboard, mouse, and so on. This test is usually referred to as a POST (Power On Self Test). At the time of operation of a POST, the BIOS outputs values from each step of the POST to certain input/output addresses. An input/output address is usually referred to as an I/O port. When the POST is successfully completed (i.e., the startup has finished), the system loads an OS (Operating System) in a designated disk.

The values output by the BIOS are referred to as startup images. The startup images include digital codes defined by the computer manufacturer of characters of a computer, and descriptions of the characters of the computer. When the computer is powered on, the startup images are displayed in the computer monitor during the startup for the computer user to monitor the startup process.

Some users need to monitor the startup process of a remote computer when the remote computer is powered on at the same time as the user's local computer. Furthermore, in many large businesses, a user needs to monitor the startup processes of a plurality of remote computers through a local server.

In order to meet these needs, one of conventional methods tries to reach the startup images of the remote computer through monitors of the remote computer. The method helps the user's local computer to monitor the startup processes and any abnormality of the remote computer by first locating and connecting with the remote computer through a network, and then checking data (usually the startup images) on a buffer of its monitor in order to copy the data to the user's local computer. After acquiring the data, the user's local computer analyzes the data to get detail output values from the BIOS of the remote computer and then reports these values to users so that the users can browse them and further manage the remote computer by dealing with any abnormality of the remote computer when the remote computer starts up.

However, the monitor buffer depends on a specific VGA (Video Graphics Array) card, so the method described above may be limited by the particular VGA card used. Therefore, a more compatible and convenient system and method for monitoring startup processes of remote computers by a local server is desired.

### SUMMARY OF THE INVENTION

An object of the present invention is to provide a system for monitoring startup processes of remote computers by a local server, which can be compatible with various VGA (Video Graphics Array) card.

Another object of the present invention is to provide a method for monitoring a startup process of a remote computer by a local server, which can be compatible with various VGA (Video Graphics Array) card.

To achieve the first object, a preferred embodiment of a system for monitoring startup processes of remote computers from a local server is provided. The system comprises: a local server for executing a monitoring program to send requests for acquiring startup images, and to receive and display the startup images; a plurality of remote computers, each remote computer outputting startup images during the startup process, receiving a request for acquiring the startup images from the local server, and transmitting the startup images to the local server, the remote computer comprising: a CPU (Central Processing Unit) for performing the startup process of the remote computer; a BIOS (Basic Input/Output System) data area for storing BIOS data of the remote computer; a video memory for storing VGA (Video Graphics Array) data; a PCI (Peripheral Component Interconnect) monitoring & managing card for detecting a VGA mode, capturing corresponding VGA data in accordance with the detected VGA mode, and translating the captured VGA data into the startup images; and a PCI bus for connecting the PCI monitoring & managing card with the CPU, the BIOS data area, and the video memory; and a network connecting the local server with the remote computers.

To achieve the second object, a preferred embodiment of a method for monitoring a startup process of a remote computer by a local server is provided. The method comprises the steps of: executing a monitoring program in the local server; capturing startup images during the startup process of the remote computer; transmitting the startup images to the local server; and displaying the startup images on the local server.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic diagram of hardware infrastructure of a system for monitoring startup processes of remote computers by a local server, in accordance with the preferred embodiment of the present invention;

FIG. 2 is a schematic diagram of internal structure of a remote computer and the local server, in accordance with the preferred embodiment of the present invention; and

FIG. 3 is a flow chart of a preferred method for monitoring a startup process of one of the remote computers by the local server, in accordance with the present invention.

### DETAILED DESCRIPTION OF THE INVENTION

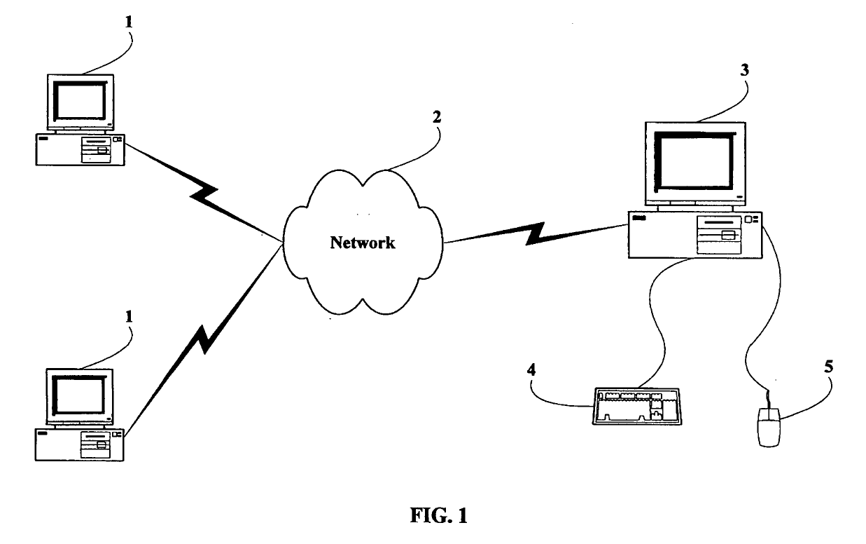

FIG. 1 is a schematic diagram of hardware infrastructure of a system for monitoring startup processes of remote computers by a local server (hereinafter, “the system”), in accordance with the preferred embodiment of the present invention. The system comprises a local server 3, a plurality of remote computers 1 (only two shown), and a network 2 connecting the local server 3 with the remote computers 1. The network 2 is an electronic communications network that supports a Transmission Control Protocol and an Internet Protocol (TCP/IP). The network 2 can be an intranet, the Internet, or any other suitable type of communications network. The system may further comprise a keyboard 4 and a mouse 5 connected to the local server 3, as input devices for a user to operate the local server 3. In the preferred embodiment of the present invention, the user operates the local server 3 to monitor the startup processes of the remote computers 1 through the network 2.

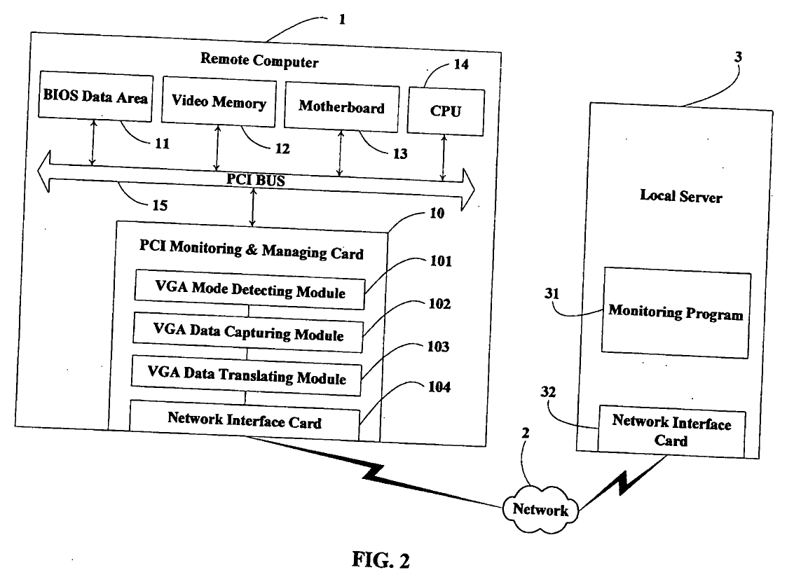

FIG. 2 is a schematic diagram of internal structure of a remote computer 1 and the local server 3, in accordance with the preferred embodiment of the present invention.

The local server 3 has a monitoring program 31 installed therein, and comprises a network interface card 32 for providing an interface to connect the local server 3 with the network 2. The local server 3 sends requests for acquiring startup images to the remote computers 1, and receives the startup images from the remote computers 1 through the network 2.

Each of the remote computers 1 outputs startup images during the startup process, and transmits the startup images to the local server 3 through the network 2 according to a request received from the local server 3. The remote computer 1 comprises a PCI (Peripheral Component Interconnect) monitoring & managing card 10, a BIOS (Basic Input/Output System) data area 11, a video memory 12 of a display device of the remote computer 1, a motherboard 13, a CPU (Central Processing Unit) 14, and a PCI bus 15.

The CPU 14 is used for performing the startup process of the remote computer 1. The BIOS data area 11 is used for storing BIOS data of the remote computer 1. The video memory 12 is used for storing VGA (Video Graphics Array) data. The PCI monitoring & managing card 10 is used for detecting a VGA mode, capturing corresponding VGA data in accordance with the detected VGA mode, and translating the captured VGA data into the startup images to be transmitted to the local server 3. The motherboard 13 includes a plurality of chipsets embedded thereon, such as a south bridge chipset, a north bridge chipset, and an Intel 8042 chipset which can control operations of the CPU 14, such as pausing or activating the CPU 14. The PCI bus 15 is used for connecting the PCI monitoring & managing card 10 with the CPU 14, the BIOS data area 11, the video memory 12, and the motherboard 13.

The PCI monitoring & managing card 10 comprises: a VGA mode detecting module 101 for detecting a VGA mode according to BIOS data stored in the BIOS data area 11; a VGA data capturing module 102 for capturing corresponding VGA data in accordance with the detected VGA mode from the video memory 12; and a VGA interpreting module 103 for translating the captured VGA data into startup images. The PCI monitoring & managing card 10 may further comprise a network interface card 104, for providing an interface to connect the PCI monitoring & managing card 10 with the network 2, and for transmitting the startup images to the local server 3 through the network 2.

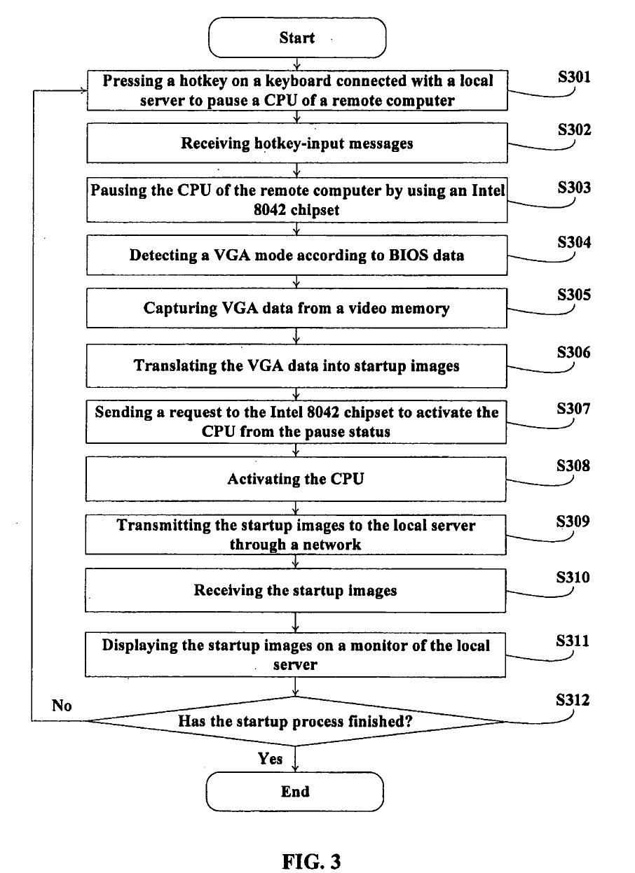

FIG. 3 is a flow chart of a preferred method for monitoring a startup process of one of the remote computers 1 by the local server 3, in accordance with the present invention. The method mainly comprises the steps of: executing the monitoring program 31 in the local server 3; capturing startup images generated during the startup process of the remote computer 1; transmitting the startup images to the local server 3; and displaying the startup images on an output device of the local server 3. The procedure is described in detail below.

Once powered on, the remote computer 1 begins outputting startup images. In step S301, the local server 3 executes the monitoring program 31, and sends a request for acquiring the startup images to the remote computer 1. The request can be hotkey-input messages generated by pressing a hotkey on the keyboard 4 connected to the local server 3. In step S302, the network interface card 104 of the remote computer 1 receives the hotkey-input messages from the local server 3. In step S303, the remote computer 1 receives the hotkey-input messages, and pauses the CPU 14 by using the Intel 8042 chipset on the motherboard 13. The next 3 steps (S304, S305, and S306) collectively make up the capturing step of the method. In step S304, the VGA mode detecting module 101 detects a VGA mode according to BIOS data from the BIOS data area 11. In step S305, the VGA data capturing module 102 captures corresponding VGA data in accordance with the detected VGA mode from the video memory 12. In step S306, the VGA interpreting module 103 translates the captured VGA data into the startup images. In step S307, the PCI monitoring & managing card 10 of the remote computer 1 sends a request to the Intel 8042 chipset to activate the CPU 14 from the pause status. In step S308, the Intel 8042 chipset receives the request from the PCI monitoring & managing card 10, and activates the CPU 14 from the pause status. In step S309, the PCI monitoring & managing card 10 transmits the startup images to the local server 3 through the network 2. In step S310, the local server 3 executes the monitoring program 31 to receive the startup images from the remote computer 1. In step S311, the local server 3 executes the monitoring program 31 to display the startup images on an output device such as a monitor. Then, in step S312, the PCI monitoring & managing card 10 determines if the startup process has finished. If the startup process has finished, the procedure ends; otherwise, the procedure returns to step S301 described above. The above-described steps can be repeated by the local server 3 in order to monitor the startup processes of various remote computers 1 one by one or synchronously according to particular user requirements.

Although the present invention has been specifically described on the basis of a preferred embodiment and preferred methods, the invention is not to be construed as being limited thereto. Various changes or modifications may be made to the embodiment and methods without departing from the scope and spirit of the invention.

1. A system for monitoring startup processes of remote computers by a local server, comprising:
a local server for executing a monitoring program to send requests for acquiring startup images, and to receive and display the startup images;
a plurality of remote computers, each remote computer outputting startup images during the startup process, receiving a request for acquiring the startup images from the local server, and transmitting the startup images to the local server, the remote computer comprising:
a CPU (Central Processing Unit) for performing the startup process of the remote computer;
a BIOS (Basic Input/Output System) data area for storing BIOS data of the remote computer;
a video memory for storing VGA (Video Graphics Array) data;
a PCI (Peripheral Component Interconnect) monitoring & managing card for detecting a VGA mode, capturing corresponding VGA data in accordance with the detected VGA mode, and translating the captured VGA data into the startup images; and
a PCI bus for connecting the PCI monitoring & managing card with the CPU, the BIOS data area, and the video memory; and
a network connecting the local server with the remote computers.

2. The system as claimed in claim 1, wherein the PCI monitoring & managing card comprises:
a VGA mode detecting module for detecting the VGA mode according to BIOS data from the BIOS data area;
a VGA data capturing module for capturing the corresponding VGA data in accordance with the detected VGA mode from the video memory; and
a VGA interpreting module for translating the captured VGA data into the startup images.

3. The system as claimed in claim 2, wherein the PCI monitoring & managing card further comprises a network interface card, for providing an interface to connect the PCI monitoring & managing card with the network, and for transmitting the startup images from the remote computer to the local server through the network.

4. The system as claimed in claim 1, wherein the local server further comprises a network interface card, for providing an interface to connect the local server with the network, for sending requests for acquiring the startup images from the remote computers, and for receiving the startup images through the network.

5. The system as claimed in claim 1, wherein the remote computer further comprises a motherboard with an Intel 8042 chipset installed thereon, for pausing the CPU when receiving the request for acquiring the startup images from the local server.

6. The system as claimed in claim 5, wherein the Intel 8042 chipset is also used for activating the CPU after the PCI monitoring & managing card translates the captured VGA data into the startup images.

7. The system as claimed in claim 1, wherein the request for acquiring the startup images received by the remote computer comprises hotkey-input messages which are generated by pressing a hotkey on a keyboard connected to the local server.

8. A method for monitoring a startup process of a remote computer by a local server, comprising the steps of:
executing a monitoring program in the local server;
capturing startup images during the startup process of the remote computer;
transmitting the startup images to the local server; and
displaying the startup images on the local server.

9. The method as claimed in claim 8, further comprising the step of determining whether the startup process has finished.

10. The method as claimed in claim 8, wherein the executing step comprises the steps of:
sending a request for acquiring the startup images from the local server to the remote computer through a network;
receiving the startup images from the remote computer by the local server; and
displaying the received startup images.

11. The method as claimed in claim 10, further comprising the step of receiving the request for acquiring the startup images from the local server by the remote computer.

12. The method as claimed in claim 11, further comprising the step of pausing a CPU (Central Processing Unit) of the remote computer by using an Intel 8042 chipset installed on a motherboard of the remote computer.

13. The method as claimed in claim 12, wherein the capturing step comprises the steps of:
detecting a VGA (Video Graphics Array) mode according to BIOS (Basic Input/Output System) data from a BIOS data area of the remote computer;
capturing corresponding VGA data in accordance with the detected VGA mode from a video memory of the remote computer; and
translating the captured VGA data into the startup images.

14. The method as claimed in claim 13, further comprising the step of activating the CPU from a pause status by using the Intel 8042 chipset after the captured VGA data have been translated into the startup images.

15. A method for monitoring a startup process of a remote computer by a server, comprising the steps of:
establishing connection between said remote computer and said server;
starting a monitoring program of said server;
requesting information of said startup process of said remote computer through said monitoring program;
identifying a mode of a display device of said remote computer based on a basic input/output system (BIOS) data of said remote computer;
retrieving said information during said startup process of said remote computer based on said identified mode of said display device of said remote computer; and
displaying said information on said server by means of said monitoring program.

16. The method as claimed in claim 15, further comprising the step of pausing said startup process of said remote computer after said remote computer receives an information request from said sever, and the step of resuming said startup process after said mode-identifying step.
